(19) United States
(12) Patent Application Publication
(10) Pub. No.: US 2020/0023603 A1
(43) Pub. Date: Jan. 23, 2020

(54) CORRUGATED CARDBOARD SHEET FEEDING APPARATUS AND BOX MAKING MACHINE

(71) Applicant: MITSUBISHI HEAVY INDUSTRIES MACHINERY SYSTEMS, LTD., Hyogo (JP)

(72) Inventors: Kazuya AKITA, Hiroshima (JP); Makoto SHIMOHATSUBO, Hiroshima (JP)

(21) Appl. No.: 16/484,847

(22) PCT Filed: Feb. 8, 2018
(86) PCT No.: PCT/JP2018/004304

§ 371 Date: Aug. 9, 2019

(30) Foreign Application Priority Data
Feb. 10, 2017 (JP) 2017-023229

(51) Int. Cl. B31B 50/04; B31B 50/88; B31B 50/25; B31B 50/20; B31B 50/26; B31B 50/62; B31B 50/98; B31B 50/00; B31B 50/07; B65H 1/06; B65H 3/10

(52) U.S. Cl. CPC B31B 50/042; B31B 50/88; B31B 50/25; B31B 50/20; B31B 50/26; B31B 2120/302; B31B 50/98; B31B 50/005; B31B 50/07; B65H 1/06; B65H 3/10; B31B 50/624

(57) ABSTRACT

A corrugated cardboard sheet feeding apparatus, which comprises: an upstream-side conveying unit which conveys a corrugated cardboard sheet mounted on delivery rollers; and a downstream-side conveying unit which is adjacent to the downstream side of the upstream-side conveying unit and conveys, to a sheet processing unit, the corrugated cardboard sheet delivered from the upstream-side conveying unit. The downstream-side conveying unit has: a downstream-side suction unit which has openings facing a sheet conveyance path; and feed rollers with a portion of the outer peripheral surfaces thereof protruding towards the sheet conveyance path, which are accommodated in the downstream-side suction unit. The distance between the downstream ends of the openings and the axis of the most-downstream-side delivery rollers is set to be not larger than the maximum range of the distance between the conveyance rollers of the sheet processing unit.

### TECHNICAL FIELD

The present invention relates to a corrugated fiberboard feeding apparatus suitable for being used in a sheet feeding section of a sheet processing machine such as a box making machine, and the box making machine in which the corrugated fiberboard feeding apparatus is used.

### BACKGROUND ART

A box making machine that processes a corrugated fiberboard includes, for example, a sheet feeding section, a printing section, a slotter creaser section, a die cutting section, a folding section, and a counter-ejector section in this order from an upstream side, and processes the corrugated fiberboard supplied from the sheet feeding section, thereby manufacturing a corrugated box.

A corrugated fiberboard feeding apparatus is mounted on the sheet feeding section of the box making machine.

As a corrugated fiberboard feeding apparatus of the related art, there is a so-called a lead edge system feeding apparatus that delivers a corrugated fiberboard stacked on a paper supply table one by one starting in turn from a sheet on the lowermost layer to a downstream side while adsorbing the sheet under negative pressure.

The representative lead edge system feeding apparatus further includes a suction transporting device for stably transporting the corrugated fiberboard at the same speed, the corrugated fiberboard being delivered in turn and being accelerated, to a printing section, which is the next step. In such a suction transporting device, the corrugated fiberboard is pulled to transport rollers or a transport belt side while being transported by the transport rollers or a transport belt, compared to a transporting device that presses and transports a corrugated fiberboard with upper and lower transport rollers. Thus, a crumpling amount of the corrugated fiberboard can be reduced.

For example, a technique in which a vacuum box adsorbs a corrugated fiberboard to pull the corrugated fiberboard to an endless belt and the endless belt delivers the corrugated fiberboard in turn to the downstream side is disclosed in PTL 1. On the downstream side of the vacuum box, a vacuum plenum for pulling the corrugated fiberboard delivered from a vacuum box side to another endless belt is disposed in a loop of this endless belt, and an upper surface of the corrugated fiberboard is pressed by a paperboard guide while being transported to a printing cylinder by this endless belt.

In addition, a technique of adsorbing a corrugated fiberboard stacked on a sheet feeding section hopper one by one starting from a sheet on the lowermost layer to deliver the corrugated fiberboard one by one by an ejection roller and adsorbing and transporting the delivered corrugated fiberboard at the same speed as a printing section by a feed roll accommodated in a suction box is disclosed in PTL 2.

### CITATION LIST

### Patent Literature

[PTL 1] Japanese Unexamined Patent Application Publication No. 6-227691

[PTL 2] Japanese Unexamined Patent Application Publication No. 9-295719

### SUMMARY OF INVENTION

### Technical Problem

However, in a corrugated box manufacturing factory, a corrugated box is manufactured according to an order from a client through a box making machine from a variety of lengths of corrugated fiberboards including a corrugated fiberboard which is long in a transfer direction or a corrugated fiberboard which is short in the transfer direction.

The corrugated fiberboard feeding apparatuses of the related art cannot obtain sufficient transporting power in some cases particularly when feeding the first corrugated fiberboard of each order and in a case where the corrugated fiberboard is a corrugated fiberboard which is short in the transfer direction (hereinafter, also referred to as a “short sheet”).

The reason will be described. The apparatus of PTL 1 and the apparatus of PTL 2 are apparatuses that transport a corrugated fiberboard with the endless belt or the ejection roller while causing adsorbing power from an opening of the vacuum plenum or the suction box to act on the corrugated fiberboard. The adsorbing power acting on the corrugated fiberboard from the opening of the vacuum plenum or the suction box acts most effectively when the corrugated fiberboard completely covers the opening.

However, in the apparatus of PTL 1 and the apparatus of PTL 2, in a case of feeding the short sheet, particularly the first short sheet, a state where the downstream side of the opening of the vacuum plenum or the suction box cannot be covered and a part of the opening is open is caused since the short sheet delivered from the upstream side is short. As a result, negative pressure for pulling the short sheet to the endless belt or the ejection roller becomes insufficient. For this reason, predetermined transporting power with respect to the printing section on the downstream side becomes insufficient, and thus the endless belt or the ejection roller slips with respect to the short sheet. Accordingly, a quality decrease, such as a shift of a printing position, occurs in some cases.

Using a large-scale blower having high suction power in a blower that is connected to the vacuum plenum or the suction box is also considered as a countermeasure for the transporting power insufficiency. However, an increase in facility costs or power supply, noise in a factory, and a problem in terms of layout occur by using the large-scale blower.

The present invention is devised in view of such problems, and an object thereof is to provide a corrugated fiberboard feeding apparatus that can stably transport a variety of long and short corrugated fiberboards to a sheet processing unit with predetermined transporting power.

### Solution to Problem

(1) According to an aspect of the present invention, in order to achieve the object, there is provided a corrugated fiberboard feeding apparatus including an upstream transporting unit that has a plurality of ejection rollers which eject a corrugated fiberboard placed on upper surfaces thereof, and transports the corrugated fiberboard placed on the ejection rollers and a downstream transporting unit that is adjacent to a downstream side in a sheet transfer direction with respect to the upstream transporting unit and transports the corrugated fiberboard ejected from the upstream transporting unit to a sheet processing unit on the downstream side. The downstream transporting unit has a downstream suction unit that has an opening facing a sheet transport passage and a feed roller that is accommodated in the downstream suction unit and has an outer circumferential surface of which a part protrudes to a sheet transport passage side. A distance in the sheet transfer direction between a downstream end of the opening in the sheet transfer direction and an axis of the ejection roller on the most downstream side in the sheet transfer direction, out of the plurality of ejection rollers, is set to a maximum distance of a mutual distance between a plurality of transport rollers of the sheet processing unit, which transport the corrugated fiberboard, or shorter.

In such a configuration, even when a dimension of the corrugated fiberboard along the sheet transfer direction is the same length as the maximum distance, that is, a minimum length that allows to be handled by the sheet processing unit, the corrugated fiberboard placed on the plurality of ejection rollers is transported in the transfer direction, and the corrugated fiberboard completely covers the opening of the downstream suction unit at a time point when a trailing end of the corrugated fiberboard leaves the outer circumferential surface of the ejection roller disposed on the most downstream side and transporting power cannot be obtained from the ejection rollers any longer. Accordingly, appropriate negative pressure works in the downstream suction unit in which the opening is covered.

Therefore, since the corrugated fiberboard is reliably drawn toward the feed roller due to suction power acting from the opening, the occurrence of slip between the feed roller and the corrugated fiberboard can be suppressed, and appropriate transporting power by the feed roller can be received.

By applying appropriate negative pressure at all times in such a manner, the corrugated fiberboard can be transported to the sheet processing unit at an appropriate position, and a variety of long and short corrugated fiberboards can be stably transported to the sheet processing unit on the downstream side in the sheet transfer direction.

(2) In the corrugated fiberboard feeding apparatus of the present invention, it is preferable that the downstream transporting unit further have, above the feed roller, a pressing mechanism that regulates an upper surface of the ejected corrugated fiberboard.

By the pressing mechanism lightly gripping the corrugated fiberboard in cooperation with the feed roller below, it is possible to stably transport the corrugated fiberboard without fluttering.

(3) In the corrugated fiberboard feeding apparatus of the present invention, it is preferable that the pressing mechanism be a pressing roll that comes into contact with the upper surface of the corrugated fiberboard which is being transported, is rotatably provided, and includes a hollow portion.

Since the pressing roll includes the hollow portion and has high elasticity, it is possible to transport the corrugated fiberboard without crumpling.

(4) In the corrugated fiberboard feeding apparatus of the present invention, it is preferable that a plurality of the feed rollers be arranged in the sheet transfer direction.

Therefore, since the transported corrugated fiberboard is supported by the feed rollers below at a plurality of positions along the sheet transfer direction, it is possible to stably transport the corrugated fiberboard without the corrugated fiberboard fluttering.

(5) In the corrugated fiberboard feeding apparatus of the present invention, it is preferable that the plurality of the feed rollers be further arranged along a sheet width direction orthogonal to the sheet transfer direction and be arranged in a zigzag.

Therefore, since the corrugated fiberboard more uniformly comes into contact with the outer circumferential surfaces of the feed rollers with respect to a surface direction, stable transporting is possible.

(6) In the corrugated fiberboard feeding apparatus of the present invention, it is preferable that a plurality of the feed rollers be provided, the opening be provided at each position of the plurality of the feed rollers, and each of the feed rollers have the outer circumferential surface of which a part protrudes from the opening.

Therefore, it is possible to make a size of the opening of the downstream suction unit to the minimum extent required, and it is possible to stabilize negative pressure inside the downstream suction unit.

(7) In the corrugated fiberboard feeding apparatus of the present invention, it is preferable that the downstream transporting unit have an auxiliary suction unit that is disposed on the downstream side of the downstream suction unit and has an opening facing the sheet transport passage and a feed roller that is accommodated in the auxiliary suction unit and has an outer circumferential surface of which a part protrudes to the sheet transport passage.

Since a length of the suction unit in the sheet transfer direction is set with the minimum length of the corrugated fiberboard as reference, suction power with respect to the corrugated fiberboard becomes insufficient and there is a possibility that sufficient transporting power cannot be obtained when transporting the corrugated fiberboard longer than the minimum length. However, the insufficiency can be complemented by providing the auxiliary suction unit.

(8) In the corrugated fiberboard feeding apparatus of the present invention, it is preferable that an upstream suction unit on an upstream side of the downstream suction unit be further included. It is preferable that the upstream suction unit, the downstream suction unit, and the auxiliary suction unit are each independently connected with a suction blower.

Therefore, it is possible to independently supply suction power of each suction blower and negative pressure in each suction unit. In addition, even in a case where a part of the suction unit is open without being covered with the corrugated fiberboard when transporting the corrugated fiberboard, negative pressure in the other suction unit can be maintained constant, and it is possible to stably transport the corrugated fiberboard.

(9) In the corrugated fiberboard feeding apparatus of the present invention, it is preferable that an upstream suction unit on an upstream side of the downstream suction unit be further included. It is preferable that adjusting means for adjusting suction power be included in each of the upstream suction unit, the downstream suction unit, and the auxiliary suction unit.

Therefore, each of the upstream suction unit, the downstream suction unit, and the auxiliary suction unit can be individually adjusted, and thus fine adjustment can be performed while balancing suction power between the suction units.

(10) In the corrugated fiberboard feeding apparatus of the present invention, it is preferable that suction power of each of the suction blowers be configured to be adjustable based on a weight per unit area of the transported corrugated fiberboard.

In a case of transporting the corrugated fiberboard having a small weight per unit area, friction between the corrugated fiberboard and the feed rollers reduces by an amount that the weight is made small and the feed rollers become likely to slip. However, by adjusting and increasing suction power of the blowers, the corrugated fiberboard can be strongly pulled to the feed rollers, and stable transporting is possible.

(11) In the corrugated fiberboard feeding apparatus of the present invention, it is preferable that an upstream suction unit on an upstream side of the downstream suction unit be further included. It is preferable that a plurality of suction boxes be provided, along a sheet width direction orthogonal to the sheet transfer direction, in at least one suction unit of the upstream suction unit, the downstream suction unit, and the auxiliary suction unit, and in each passage that connects the plurality of suction boxes to the suction blowers, a shutter member that opens and closes the passage be included.

Therefore, out of the suction boxes provided along the sheet width direction, a suction box to be operated can be set according to a sheet width dimension of the corrugated fiberboard without excess or insufficiency.

(12) In the corrugated fiberboard feeding apparatus of the present invention, it is preferable that the upstream transporting unit include a grate that separates the corrugated fiberboard on the lowermost layer away from the plurality of ejection rollers at a raised position higher than a height of each of upper edges of the plurality of ejection rollers, and brings the corrugated fiberboard on the lowermost layer into contact with the ejection rollers at a lowered position lower than the height of each of the upper edges and a drive device that drives the grate to raise and lower the grate between the raised position and the lowered position. It is preferable that adjusting means for adjusting suction power be included in each of the upstream suction unit and the downstream suction unit, and the adjusting means set at least the suction power of the downstream suction unit to the suction power of the upstream suction unit or larger.

Although the suction power of the upstream transporting unit has to be large enough to pull the corrugated fiberboard to the ejection rollers, the suction power serves as resistance when raising the grate. Thus, there is an upper limit.

On the other hand, the suction power of the downstream transporting unit can be set to strength that only considered pulling the corrugated fiberboard to the feed rollers.

Therefore, the suction power of the downstream transporting unit is set to power that is equal to or larger than the suction power of the upstream transporting unit. Accordingly, the transporting power of the feed rollers can be reliably transmitted to the corrugated fiberboard by pulling the corrugated fiberboard to the feed rollers. Even when the ejection rollers slip due to insufficiency of the suction power of the upstream transporting unit, the corrugated fiberboard can be transported to the sheet processing unit without slipping at the downstream transporting unit.

(13) According to another aspect of the present invention, there is provided a box making machine including a sheet feeding section that feeds a corrugated fiberboard one by one, a printing section that prints the corrugated fiberboard fed from the sheet feeding section, a slotter creaser section that performs groove cutting and creasing line processing onto the corrugated fiberboard printed by the printing section, a die cutting section that performs punching processing onto the corrugated fiberboard on which the groove cutting and the creasing line processing are performed, a folder gluer section that applies glue to an end portion of the corrugated fiberboard processed by the die cutting section and performs folding processing to form a sheet-like corrugated box, and a counter-ejector section that stacks the corrugated box processed by the folder gluer section while counting the number of the corrugated box. The corrugated fiberboard feeding apparatus according to any one of (1) to (12) is provided in the sheet feeding section.

By using the corrugated fiberboard feeding apparatus according to any one of (1) to (12), the corrugated fiberboard can be stably transported to the printing section, and a quality decrease, such as a shift of a printing position, can be suppressed.

### Advantageous Effects of Invention

Since the distance between the downstream end of the opening of the downstream suction unit and the axis of the ejection roller on the most downstream side is set to be equal to or shorter than the maximum distance of the mutual distance between the transport rollers of the sheet processing unit, the corrugated fiberboard completely covers the opening of the downstream suction unit at a time point when the trailing end of the corrugated fiberboard leaves the ejection roller on the most downstream side and transporting power cannot be obtained any longer even when the dimension of the corrugated fiberboard along the sheet transfer direction is the maximum distance, that is, the minimum length of the corrugated fiberboard that allows to be handled by the sheet processing unit.

Accordingly, suction power from the opening effectively acts on the corrugated fiberboard, and the corrugated fiberboard is pulled to the feed rollers. Thus, appropriate transporting power can be received from the feed rollers.

Therefore, the corrugated fiberboard can be transported to the sheet processing unit at an appropriate position, and a variety of long and short corrugated fiberboards can be stably transported to the sheet processing unit.

### BRIEF DESCRIPTION OF DRAWINGS

FIG. 1 is a schematic side view illustrating a configuration of a box making machine including a corrugated fiberboard feeding apparatus according to a first embodiment of the present invention.

FIG. 2 is a schematic plan view illustrating an overall configuration of the corrugated fiberboard feeding apparatus according to the first embodiment of the present invention.

FIG. 3 is a schematic sectional view illustrating the overall configuration of the corrugated fiberboard feeding apparatus according to the first embodiment of the present invention, which is seen from a side.

FIG. 4 is a schematic view illustrating the overall configuration of the corrugated fiberboard feeding apparatus according to the first embodiment of the present invention, and is a sectional view taken along arrow A-A of FIG. 2.

FIG. 5 is a view for describing “a minimum length of a corrugated fiberboard” in the first embodiment of the present invention, and is a schematic side view of a slotter creaser section and a die cutting section.

FIG. 6 is a schematic sectional view of main portions for describing operational effects of the corrugated fiberboard feeding apparatus according to the first embodiment of the present invention, which is seen from the side.

FIG. 7 is a schematic sectional view illustrating a main portion configuration of a corrugated fiberboard feeding apparatus according to a second embodiment of the present invention, which is seen from the side.

### DESCRIPTION OF EMBODIMENTS

Hereinafter, suitable embodiments of a corrugated fiberboard feeding apparatus and a box making machine of the present invention will be described in detail with reference to accompanying drawings. The present invention is not limited to the embodiments. In a case where there are a plurality of embodiments, the present invention also includes an apparatus configured by combining the respective embodiments.

In the following description, “upstream” means an upstream side in a sheet transfer direction X, which is a transfer direction of a corrugated fiberboard, unless there is no special description otherwise, and “downstream” means a downstream side in the sheet transfer direction X unless there is no special description otherwise. In addition, hereinafter, a corrugated fiberboard width direction, which is a direction orthogonal to the sheet transfer direction X, will be referred to as a “sheet width direction W”.

### 1. First Embodiment

[1-1. Configuration of Box Making Machine]

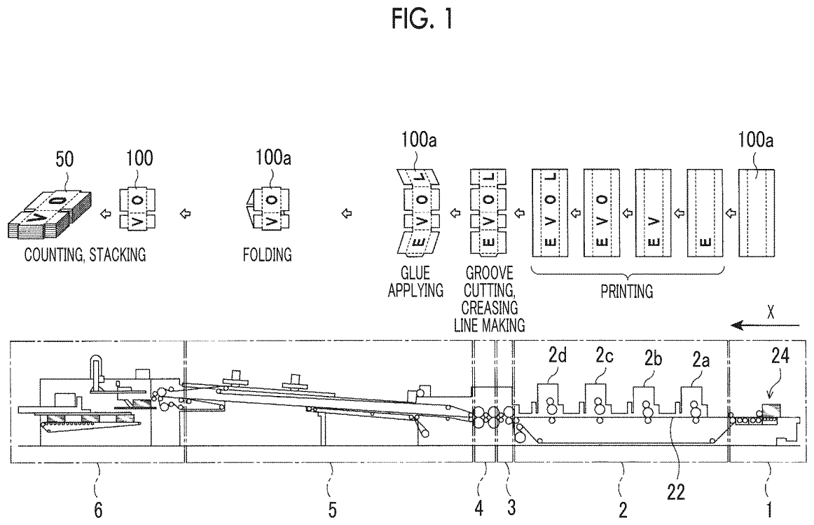

First, a configuration of the box making machine including a corrugated fiberboard feeding apparatus 24 according to the embodiment will be described in detail with reference to FIG. 1.

Each configuration of a representative box making machine and a process in which a corrugated fiberboard is processed into a sheet-like corrugated box are correlated with each other and described in FIG. 1. As illustrated in FIG. 1, sheet processing units including a sheet feeding section 1, a printing section 2, a slotter creaser section 3, a die cutting section 4, a folder gluer section 5, and a counter-ejector section 6 are provided in this order from the upstream side in the box making machine. Various types of processing to be described below are performed onto the corrugated fiberboard while being transported along a horizontal sheet transport passage formed with a conveyor for transporting and a roll for transporting, from the sheet feeding section 1 to the folder gluer section 5.

In the sheet feeding section 1, the corrugated fiberboard feeding apparatus 24 according to the first embodiment of the present invention is provided, and a plate-shaped corrugated fiberboard 100a is placed. The corrugated fiberboard 100a on the lowermost layer is started to be transported in turn one by one to the printing section 2.

For example, the printing section 2 is formed with printing units 2a to 2d for four colors. In the printing section 2, printing is performed in turn onto the corrugated fiberboard 100a transported one by one by a transport conveyor belt 22 with each color of ink.

In the slotter creaser section 3, groove cutting or creasing line processing is performed onto the corrugated fiberboard 100a printed by the printing section 2.

In the die cutting section 4, punching processing, further groove cutting, or further creasing line processing is performed onto the corrugated fiberboard 100a transported from the slotter creaser section 3.

In the folder gluer section 5, glue is applied to a gluing margin of one end of the corrugated fiberboard 100a processed by the die cutting section 4 in the sheet width direction W, and folding processing is performed such that both of right and left end portions of the corrugated fiberboard 100a are bonded on a lower side. By both of the right and left end portions being bonded to each other with glue, the corrugated fiberboard 100a processed by the folder gluer section 5 becomes a sheet-like corrugated box 100.

While the counter-ejector section 6 counts the number of sheet-like corrugated boxes 10 which are processed by the folder gluer section 5, the corrugated boxes are placed onto a table. After a predetermined number of corrugated boxes 100 are stacked by the counter-ejector section 6, this sheet material group 50 is shipped as a single unit batch.

[1-2. Corrugated Fiberboard Feeding Apparatus]

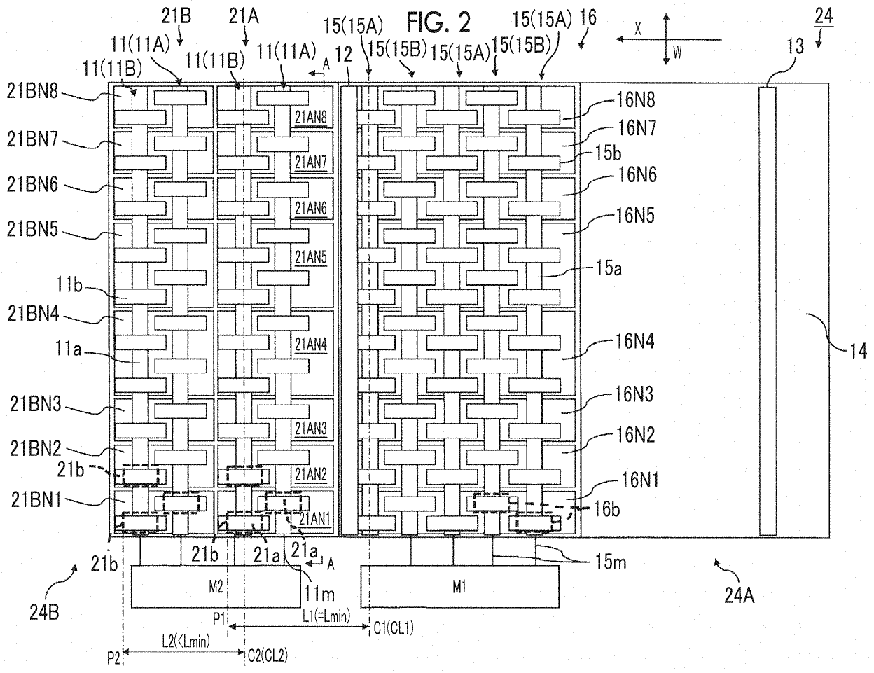

Next, the corrugated fiberboard feeding apparatus 24 included in the sheet feeding section 1 according to the first embodiment of the present invention will be described in detail with reference to FIGS. 2 to 6.

As illustrated in FIGS. 2 to 4, the sheet feeding apparatus 24 is configured to include an upstream transporting unit 24A and a downstream transporting unit 24B on the downstream side of the upstream transporting unit 24A.

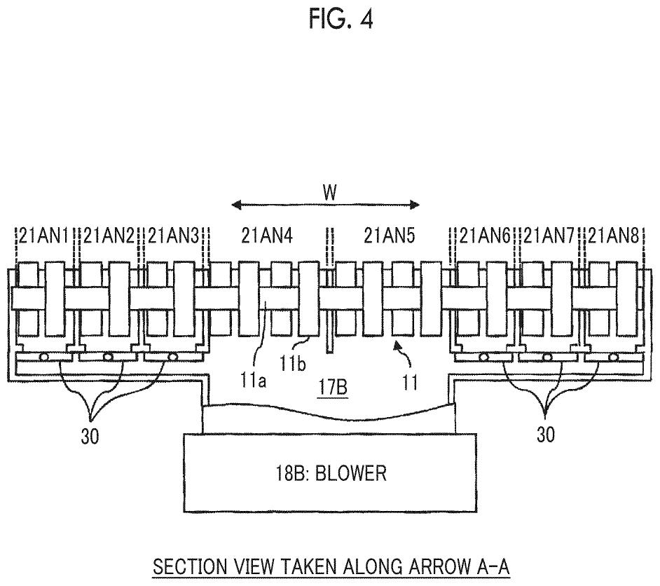

Although a state where a grate 16a to be described later is removed from the upstream transporting unit 24A, and a state where each ceiling surface of a box-shaped downstream suction unit 21A and a box-shaped auxiliary suction unit 21B is removed from all parts of the downstream transporting unit 24B are illustrated in FIGS. 2 and 4, openings 16b provided in the grate 16a and openings 21a provided in each ceiling surface of the downstream suction unit 21A and the auxiliary suction unit 21B are shown with chain lines in FIG. 2 for convenience of description.

[1-2-1. Upstream Transporting Unit]

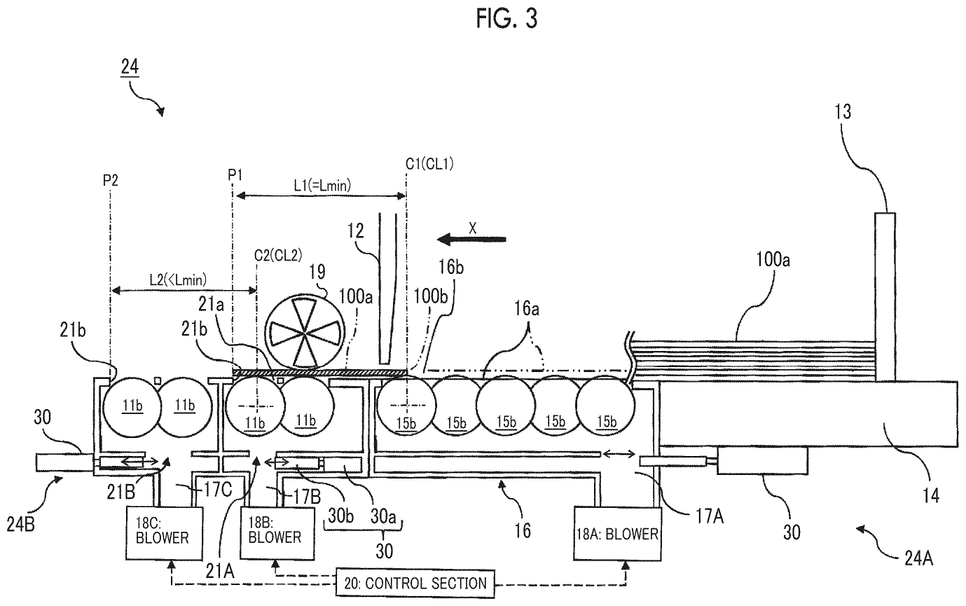

First, the upstream transporting unit 24A will be described with reference to FIGS. 2 and 3.

In the upstream transporting unit 24A, the corrugated fiberboard 100a, which is put in one by one from a transporting device (not illustrated) of the previous step, abuts against a front guide 12 and falls, and is stacked in turn onto a paper supply table 14 between a backstop 13 and the front guide as illustrated in FIG. 3.

As illustrated in FIG. 2, suction boxes 16N1 to 16N8 are provided along the sheet width direction W below the stacked corrugated fiberboard 100a on the lowermost layer, and the suction boxes 16N1 to 16N8 configure an upstream suction unit 16. The ejection roller assemblies 15 are arranged in five rows along the sheet transfer direction X of the corrugated fiberboard 100a and are rotatably accommodated in each of the suction boxes 16N1 to 16N8.

Each of the ejection roller assemblies 15 is configured to include a rotary shaft 15a extending in the sheet width direction W and a plurality of ejection rollers 15b arranged at predetermined pitches on the rotary shaft 15a. Each of the ejection rollers 15b protrudes to a sheet transport passage side slightly more than an upper surface of the paper supply table 14 does. Each of the ejection roller assemblies 15 is provided to penetrate the plurality of suction boxes 16N1 to 16N8 arranged in the sheet width direction W.

In addition, there are ejection roller assemblies 15A and 15B having pitches between the ejection rollers 15b that are shifted away from each other, in the ejection roller assemblies 15. By alternately arranging the ejection roller assemblies 15A and 15B in the sheet transfer direction X, the plurality of ejection rollers 15b are in a zigzag.

Each of the ejection roller assemblies 15 is connected to a drive motor M1 via a power transmission mechanism 15m illustrated in a simplified manner, and is intermittently rotation-driven by the drive motor M1.

The grate 16a is provided on an upper surface of the upstream suction unit 16 as illustrated in FIG. 3. The grate 16a is a grid-like table having each of the openings 16b (refer to dashed lines of FIG. 2) above each of the ejection rollers 15b, and is driven to be risen and lowered between a raised position, which is higher than an upper edge of each of the ejection rollers 15b and is shown with a two-dot chain line, and a lowered position, which is lower than the upper edge and is shown with a solid line, by a drive device (not illustrated). Each of the ejection rollers 15b is separated away from the corrugated fiberboard 100a when the grate 16a is at the raised position, and a part of each outer circumferential surface thereof protrudes from each opening 16b and comes into contact with the corrugated fiberboard 100a on the lowermost layer to eject the corrugated fiberboard when the grate 16a is at the lowered position.

The grate 16a repeats raising and lowering operation at appropriate timing and holds the other stacked corrugated fiberboards 100a such that only the corrugated fiberboard 100a on the lowermost layer is adsorbed and transported one by one by the rotating ejection roller assemblies 15.

FIG. 2 illustrates only some of the openings 16b since the drawing becomes complicated.

An inside of the upstream suction unit 16 is connected to a suction blower 18A via a duct 17A. Therefore, by the suction blower 18A operating, the corrugated fiberboard 100a on the lowermost layer is sucked downwards through the openings 16b facing the sheet transport passage, and is drawn to the ejection rollers 15b. Therefore, frictional resistance between the outer circumferential surfaces of the ejection rollers 15b and a lower surface of the corrugated fiberboard 100a acts strongly, and thus slip of the ejection rollers 15b with respect to the corrugated fiberboard 100a is suppressed. Accordingly, in response to the rotation operation of the ejection rollers 15b, the corrugated fiberboard 100a is stably transported from a gap formed in a lower end of the front guide 12 to the downstream side (the left of the page of FIG. 2).

[1-2-2. Downstream Transporting Unit]

Next, the downstream transporting unit 24B will be described. As illustrated in FIGS. 2 and 3, in the downstream transporting unit 24B, the downstream suction unit 21A is disposed on the downstream side of the upstream suction unit 16, and the auxiliary suction unit 21B is additionally disposed on the downstream side of the downstream suction unit 21A. The downstream suction unit 21A is provided such that suction boxes 21AN1 to 21AN8 are arranged along the sheet width direction W, as in the upstream suction unit 16 of the upstream transporting unit 24A.

In addition, also the auxiliary suction unit 21B is provided such that suction boxes 21BN1 to 21BN8 are arranged along the sheet width direction W, as in the upstream suction unit 16 of the upstream transporting unit 24A.

In each of the downstream suction unit 21A and the auxiliary suction unit 21B, feed roller assemblies 11 are arranged in two rows along the sheet transfer direction X and are rotatably accommodated.

Each of the feed roller assemblies 11 is configured to include a rotary shaft 11a extending in the sheet width direction W and a plurality of feed rollers 11b arranged at predetermined pitches on the rotary shaft 11a. Each of the feed roller assemblies 11 is provided to penetrate the plurality of suction boxes 21AN1 to 21AN8 and the suction boxes 21BN1 to 21BN8, which are arranged in the sheet width direction W.

In addition, there are feed roller assemblies 11A and 11B having pitches between the feed rollers 11b that are shifted away from each other, in the feed roller assemblies 11. By alternately arranging the feed roller assemblies 11A and 11B in the sheet transfer direction X, the feed rollers 11b are in a zigzag.

Each of the feed roller assemblies 11 is connected to a drive motor M2 via a power transmission mechanism 11m illustrated in a simplified manner, and is rotation-driven by the drive motor M2.

In an upper surface of each of the downstream suction unit 21A and the auxiliary suction unit 21B, the opening 21a is formed above each of the feed rollers 11b to face the sheet transport passage. Each of the feed rollers 11b has an outer circumferential surface of which a part protrudes from each opening 21a to the sheet transport passage side and comes into contact with the corrugated fiberboard 100a to eject the corrugated fiberboard 100a. FIG. 2 illustrates only some of the openings 21a since the drawing becomes complicated.

In addition, pressing rolls 19 are provided above the feed rollers 11b on the upstream side (the right of the page of FIG. 2) of the downstream suction unit 21A. Each of the pressing rolls 19 is a polyurethane rotating body which includes a hollow portion and has high elasticity, and rotates with the corrugated fiberboard 100a transported by the feed rollers 11b. By lightly gripping the corrugated fiberboard 100a in cooperation with the feed rollers 11b below, the pressing rolls 19 contribute to transporting the corrugated fiberboard 100a without crumpling. The plurality of pressing rolls 19 are provided at an interval along the sheet width direction W. The pressing rolls 19 are omitted in FIGS. 2 and 4.

An inside of the downstream suction unit 21A and an inside of the auxiliary suction unit 21B are connected to suction blowers 18B and 18C via ducts 17B and 17C, respectively.

Therefore, by the suction blowers 18B and 18C respectively operating, the corrugated fiberboard 100a transported by the ejection rollers 15b is sucked downwards through the openings 21a, and is drawn to the feed rollers 11b. Therefore, frictional resistance between outer circumferential surfaces of the feed rollers 11b and the lower surface of the corrugated fiberboard 100a acts strongly, and slip of the feed rollers 11b with respect to the corrugated fiberboard 100a is suppressed. Accordingly, in response to the rotation operation of the feed rollers 11b, the corrugated fiberboard 100a is stably transported to the printing section 2.

The corrugated fiberboard feeding apparatus 24 according to the first embodiment of the present invention is characteristic in that a positional relationship between the openings 21a of the downstream suction unit 21A and the ejection rollers 15b is a particular relationship.

Specifically, as illustrated in FIGS. 2 and 3, a distance L1 between a position P1 of a downstream end 21b of the downstream opening 21a of the downstream suction unit 21A in the sheet transfer direction X and a position C1 of an axis CL1 of the ejection roller 15b disposed on the most downstream side in the sheet transfer direction X is configured to be equal to or shorter than a minimum length Lmin of the corrugated fiberboard 100a to be described later (L1≤Lmin).

Herein, in a case where the plurality of openings 21a are provided in the downstream suction unit 21A along the sheet transfer direction X as in the embodiment, “the downstream end of the opening provided in the downstream suction unit in the sheet transfer direction” in the present invention means “the downstream end 21b of the opening 21a provided on the most downstream side in the sheet transfer direction X”.

In addition, the corrugated fiberboard feeding apparatus 24 according to the first embodiment of the present invention is characteristic also in that a positional relationship between the openings 21a of the auxiliary suction unit 21B and the openings 21a of the downstream suction unit 21A is a particular relationship.

Specifically, as illustrated in FIGS. 2 and 3, a distance L2 between a position P2 of the downstream end 21b of the downstream opening 21a of the auxiliary suction unit 21B in the sheet transfer direction X and a position C2 of an axis CL2 of the feed roller 11b disposed on the most downstream side in the downstream suction unit 21A in the sheet transfer direction X is configured to be equal to or shorter than the minimum length Lmin of the corrugated fiberboard 100a to be described later (L2≤Lmin).

In the embodiment, the distance L1 is set to be equal to Lmin, and the distance L2 is set to be shorter than Lmin.

Herein, in a case where the plurality of openings 21a are provided in the auxiliary suction unit 21B along the sheet transfer direction X as in the embodiment, “the downstream end of the opening provided in the auxiliary suction unit in the sheet transfer direction” in the present invention means “the downstream end 21b of the opening 21a provided on the most downstream side in the sheet transfer direction X”.

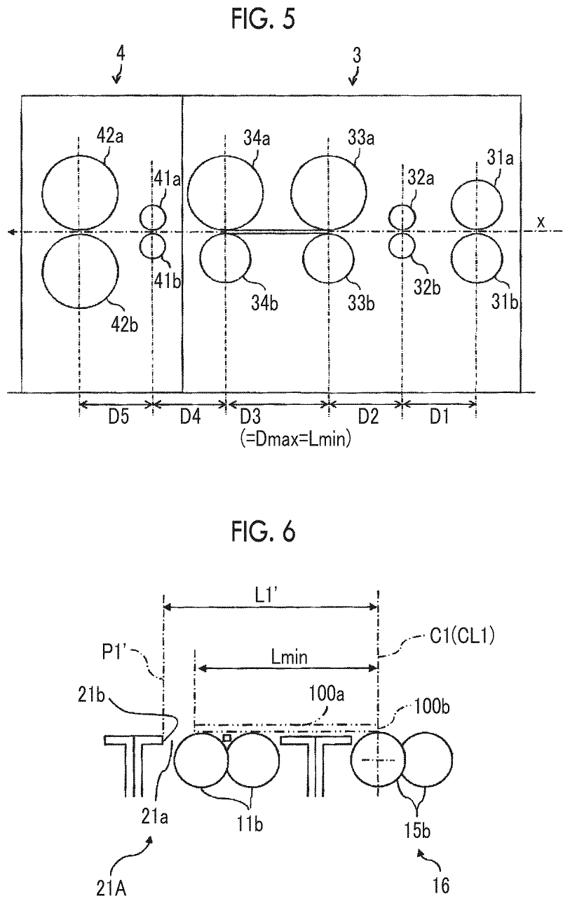

The “minimum length Lmin” will be described in detail with reference to FIG. 5. In the sheet processing units on the downstream side of the sheet feeding section 1 in the box making machine, that is, the printing section 2, the slotter creaser section 3, the die cutting section 4, the folder gluer section 5, and the counter-ejector section 6, there is a portion where transport rolls arranged at an interval in the sheet transfer direction X perform transporting of the corrugated fiberboard 100a. When a dimension of the corrugated fiberboard 100a along the sheet transfer direction X is shorter than a mutual distance between the axes of the rolls, it is difficult for the corrugated fiberboard 100a to be transferred from transport rolls on the upstream side to transport rolls on the downstream side.

That is, the transporting of a corrugated fiberboard having a dimension along the sheet transfer direction X shorter than a longest distance Dmax between the transport rolls cannot be stably performed, and the longest distance Dmax is the minimum length Lmin of the corrugated fiberboard 100a that can be stably transported by the sheet processing units. Thus, the distances L1 and L2 are set to be equal to or shorter than the minimum length Lmin. In other words, the distances L1 and L2 each are set to a distance that is equal to or shorter than the longest distance Dmax between the transport rolls in the sheet processing units (L1≤Dmax, L2≤Dmax).

The transport rolls herein may each have a function of transporting the corrugated fiberboard 100a. That is, the transport rolls are not only for transporting the corrugated fiberboard 100a but also for executing processing onto the corrugated fiberboard 100a while transporting the corrugated fiberboard 100a.

In the embodiment, sections that transport the corrugated fiberboard 100a with the transport rolls are, for example, the slotter creaser section 3 and the die cutting section 4.

As illustrated in FIG. 5, the slotter creaser section 3 includes a receiving roll 31a and a first creasing line roll 31b, a receiving roll 32a and a second creasing line roll 32b, a first slotter head 33a and a lower blade roll 33b, a second slotter head 34a and a lower blade roll 34b, which vertically oppose each other with the sheet transport passage sandwiched therebetween, in this order from the upstream side.

In addition, the die cutting section 4 includes feeding pieces 41a and 41b, and an anvil cylinder 42a and a knife cylinder 42b, which vertically oppose each other with the sheet transport passage sandwiched therebetween, in this order from the upstream side.

Hereinafter, for convenience of description, the receiving roll 31a, the first creasing line roll 31b, the receiving roll 32a, the second creasing line roll 32b, the first slotter head 33a, the lower blade roll 33b, the second slotter head 34a, and the lower blade roll 34b will also be referred to as the rolls. the Axes of the upper rolls 31a to 34a, 41a, and 42a and axes of the lower rolls 31b to 34b, 41b, and 42b, which are disposed in the slotter creaser section 3 and the die cutting section 4, respectively match each other in the sheet transfer direction X, and the corrugated fiberboard 100a is transported by being gripped by nips.

Out of distances between the nips of the rolls 31a to 34b and 41a to 42b, that is, distances D1 to D5 between the axes of the rolls 31a to 34b and 41a to 42b, the distance D3 between the first slotter head 33a and the lower blade roll 33b and the second slotter head 34a and the lower blade roll 34b is the longest. That is, in the embodiment, the distance D3 is the longest distance Dmax between the transport rolls, and is the minimum length Lmin of a corrugated fiberboard that can be stably transported by the box making machine.

[1-2-3. Suction System]

A suction system for supplying suction power to each of the upstream suction unit 16, the downstream suction unit 21A, and the auxiliary suction unit 21B will be described with reference to FIGS. 2 to 4.

The suction systems of the upstream suction unit 16, the downstream suction unit 21A, and the auxiliary suction unit 21B are included independently of each other. Specifically, the upstream suction unit 16 is connected to the suction blower 18A via the duct 17A, the downstream suction unit 21A is connected to the suction blower 18B via the duct 17B, and the auxiliary suction unit 21B is connected to the suction blower 18C via the duct 17C.

In addition, operation, stop, and output of each of the suction blowers 18A, 18B, and 18C are individually controlled by a control section 20. Therefore, by individually controlling output of each of the suction blowers 18A, 18B, and 18C, suction power can be applied differently to each of the upstream suction unit 16, the downstream suction unit 21A, and the auxiliary suction unit 21B. Thus, the suction blowers 18A, 18B, and 18C and the control section 20 configure adjusting means of the present invention, which adjusts suction power.

For example, suction power with respect to the upstream suction unit 16, the downstream suction unit 21A, and the auxiliary suction unit 21B is configured to be adjustable based on a weight per unit area of the transported corrugated fiberboard 100a. In a case of adjusting suction power based on a weight per unit area of the corrugated fiberboard 100a, specifically, the corrugated fiberboard is strongly pressed against the feed rollers 11b or the ejection rollers 15b due to the weight of the corrugated fiberboard 100a as such a weight per unit area increases. Thus, suction power is set to be low with respect to the upstream suction unit 16, the downstream suction unit 21A, and the auxiliary suction unit 21B by the pressed amount.

Since the ducts 17A, 17B, and 17C are configured in the same manner, the duct 17B connected to the downstream suction unit 21A will be mainly described.

Lower ends of the suction boxes 21AN1 to 21AN8 configuring the downstream suction unit 21A are configured as open portions, and the duct 17B is connected thereto as a common duct. A shutter mechanism 30 is provided in each of each open portion of the suction boxes 21AN1, 21AN2, 21AN3, 21AN6, 21AN7, and 21AN8 except for the suction boxes 21AN4 and 21AN5. The shutter mechanism 30 includes an air cylinder 30a and the shutter member 30b attached to a drive shaft tip of the air cylinder 30a.

When the air cylinder 30a is expanded due to such a configuration, a suction box comes into a non-use state where the open portion is blocked by the shutter member 30b and suction power from the suction blower 18B does not act. On the other hand, when the air cylinder 30a degenerates as illustrated in FIG. 3, the suction box comes into a use state where the open portion is opened and suction power acts. The middle suction boxes 21AN4 and 21AN5 are correlated with a minimum width dimension of the corrugated fiberboard 100a to be handled, and thus the shutter mechanism 30 is not provided as described above since the use state is caused at all times regardless of a width dimension of the corrugated fiberboard 100a.

The upstream suction unit 16, the downstream suction unit 21A, and the auxiliary suction unit 21B, which are disposed to be symmetrical with respect to a center line of the sheet width direction W, are used as a pair. Since the upstream suction unit 16, the downstream suction unit 21A, and the auxiliary suction unit 21B are configured in the same manner, the downstream suction unit 21A will be mainly described. Specifically, the suction boxes 21AN4 and 21AN5 are used as a pair, the suction boxes 21AN3 and 21AN6 are used as a pair, the suction boxes 21AN2 and 21AN7 are used as a pair, and the suction boxes 21AN1 and 21AN8 are used as a pair.

In this case, as the width dimension of the corrugated fiberboard 100a increases, suction boxes to become in the use state expands in turn starting from the middle suction boxes 21AN4 and 21AN5 to the outer suction boxes 21AN3 and 21AN6, the outer suction boxes 21AN2 and 21AN7, and the outer suction boxes 21AN1 and 21AN8.

In addition, suction power acts on the openings 21a of the downstream suction unit 21A is set to suction power acting on the openings 16b of the upstream suction unit 16 or larger.

[1-3. Operation and Effect]

By configuring in such a manner, even when the corrugated fiberboard 100a transported by the plurality of ejection rollers 15b has the minimum length Lmin as shown with hatching in FIG. 3, the corrugated fiberboard 100a can be appropriately transported.

That is, at a time point when a trailing end 100b of the corrugated fiberboard 100a having the minimum length Lmin leaves the outer circumferential surface of the ejection roller 15b disposed on the most downstream side and transporting power cannot be obtained from the ejection rollers 15b any longer, the corrugated fiberboard 100a completely covers the openings 21a of the downstream suction unit 21A from above as illustrated in FIG. 3.

At this time, although the openings 16b of the upstream suction unit 16 are not covered with the corrugated fiberboard 100a, the blower 18A connected to the upstream suction unit 16 and the blower 18B connected to the downstream suction unit 21A are respectively connected to the ducts 17A and 17B which are independent of each other. Therefore, appropriate negative pressure works in the downstream suction unit 21A in which the opening 21a is covered.

Therefore, since the corrugated fiberboard 100a is reliably drawn to the feed rollers 11b through the openings 21a, the corrugated fiberboard receives predetermined transporting power from the feed rollers 11b. Thus, it is possible to stably transport the corrugated fiberboard toward the printing section 2. That is, the occurrence of slip of the feed rollers 11b with respect to the corrugated fiberboard 100a can be suppressed, and the corrugated fiberboard 100a can be transported to the printing section 2 at an appropriate position. Thus, a quality decrease, such as a shift of a printing position, can be suppressed.

On the contrary, as illustrated in FIG. 6, in a case where a distance L1′ between the downstream end 21b of the opening 21a and the axis CL1 of the ejection roller 15b on the most downstream side, which is described above, is disposed to be longer than the minimum length Lmin of the corrugated fiberboard 100a, the corrugated fiberboard 100a cannot completely cover the openings 21a from above at a time point when the trailing end 100b of the corrugated fiberboard 100a leaves the outer circumferential surface of the ejection roller 15b disposed on the most downstream side.

Therefore, since the openings 21a of the downstream suction unit 21A are partially open, negative pressure is not sufficient in the openings 21a. Thus, power of drawing the corrugated fiberboard 100a to the feed rollers 11b is deficient, and the feed rollers 11b slip with respect to the corrugated fiberboard 100a. That is, the corrugated fiberboard 100a loses transporting power from the ejection rollers 15b, and sufficient transporting power cannot be obtained from the feed rollers 11b. Thus, a quality decrease, such as a shift of a printing position, occurs without the corrugated fiberboard 100a being transported to the printing section 2 at an appropriate position.

In addition, since also the distance L2 between the position P2 of the downstream end 21b of the opening 21a of the auxiliary suction unit 21B and the axis CL2 of the feed roller 11b on the most downstream side in the downstream suction unit 21A is configured to be equal to or shorter than the minimum length Lmin as illustrated in FIGS. 2 and 3, the corrugated fiberboard 100a can be appropriately transported even when the corrugated fiberboard 100a has the minimum length Lmin as in the downstream suction unit 21A.

That is, at a time point when the trailing end 100b of the corrugated fiberboard 100a having the minimum length Lmin leaves the outer circumferential surface of the feed roller 11b on the most downstream side in the downstream suction unit 21A and transporting power cannot be obtained from the feed rollers 11b any longer, the corrugated fiberboard 100a completely covers the openings 21a of the auxiliary suction unit 21B from above. Thus, appropriate negative pressure works in the auxiliary suction unit 21B.

Therefore, since the corrugated fiberboard 100a is reliably drawn to the feed rollers 11b through the openings 21a of the auxiliary suction unit 21B, the corrugated fiberboard receives predetermined transporting power from the feed rollers 11b. Thus, it is possible to stably transport the corrugated fiberboard toward the printing section 2. That is, the occurrence of slip of the feed rollers 11b with respect to the corrugated fiberboard 100a can be suppressed, and the corrugated fiberboard 100a can be transported to the printing section 2 at an appropriate position. Thus, a quality decrease, such as a shift of a printing position, can be suppressed.

In addition, since the downstream suction unit 21A is set with the minimum length Lmin of the corrugated fiberboard 100a as reference, suction power with respect to the corrugated fiberboard 100a becomes insufficient and there is a possibility that sufficient transporting power cannot be obtained when transporting the corrugated fiberboard 100a longer than the minimum length Lmin. However, the insufficiency can be complemented by providing the auxiliary suction unit 21B.

In addition, since the pressing rolls 19 each of which includes the hollow portion and has high elasticity is provided above the feed rollers 11b, it is possible to transport the corrugated fiberboard 100a without crumpling by lightly gripping the corrugated fiberboard 100a in cooperation with the feed rollers 11b below.

Although the suction power of the upstream transporting unit 24A has to be large enough to pull the corrugated fiberboard 100a to the ejection rollers 15b, the suction power serves as resistance when raising the grate 16a. Thus, there is an upper limit. On the other hand, the suction power of the downstream transporting unit 24B can be set to strength that only considered pulling the corrugated fiberboard 100a to the feed rollers 11b.

Therefore, the suction power of the downstream transporting unit 24B is set to power that is equal to or larger than the suction power of the upstream transporting unit 24A. Accordingly, the transporting power of the feed rollers 11b can be reliably transmitted to the corrugated fiberboard 100a by pulling the corrugated fiberboard 100a to the feed rollers 11b. Even when the ejection rollers 15b slip due to insufficiency of the suction power of the upstream transporting unit 24A, the corrugated fiberboard 100a can be appropriately transported to the printing section 2 without the feed rollers 11b of the downstream transporting unit 24B slipping.

Time when transporting the corrugated fiberboard 100a having a small size can be given as an example of a case where the suction power of the downstream transporting unit 24B is made stronger than the suction power of the upstream transporting unit 24A. That is because the corrugated fiberboard 100a is not flat in a strict sense and has a considerably small curve, and more gaps between the openings 21a of the downstream suction unit 21A or the auxiliary suction unit 21B and the corrugated fiberboard are generated as the size of the corrugated fiberboard 100a decreases. In this case, since an effect of a decrease in the suction power caused by the gaps becomes noticeable, the corrugated fiberboard 100a is reliably pulled to the feed rollers 11b by making the suction power of the downstream transporting unit 24B strong.

In addition, since the pressing rolls 19 are included, the flutter of the corrugated fiberboard 100a can be suppressed by lightly gripping the corrugated fiberboard 100a in cooperation with the feed rollers 11b below, and thus it is possible to stably transport the corrugated fiberboard. Since each of the pressing rolls 19 includes the hollow portion and has high elasticity in particular, the crumpling of the corrugated fiberboard 100a can be suppressed when gripping the corrugated fiberboard 100a.

In addition, since the plurality of feed rollers 11b are arranged in the sheet transfer direction X, the transported corrugated fiberboard 100a is supported by the feed rollers 11b at a plurality of positions along the sheet transfer direction X. Therefore, the flutter of the corrugated fiberboard 100a can be suppressed, and it is possible to stably transport the corrugated fiberboard 100a.

Since the feed rollers 11b are arranged in a zigzag, the corrugated fiberboard 100a more uniformly comes into contact with the feed rollers 11b with respect to a surface direction. Therefore, stable transporting is possible.

The opening 21a functioning as a suction port is provided at each position of the plurality of feed rollers 11b, and a part of each of the outer circumferential surfaces of the feed rollers 11b protrudes from the opening 21a. Therefore, compared to a case where a suction port and an opening that allows each feed roller 11b to protrude are separately provided, it is possible to make the size of each opening provided in each of the downstream suction unit 21A and the auxiliary suction unit 21B to the minimum extent required, and it is possible to stabilize negative pressure inside the downstream suction unit 21A and the auxiliary suction unit 21B.

Since the suction blowers 18A, 18B, and 18C are respectively connected to the upstream suction unit 16, the downstream suction unit 21A, and the auxiliary suction unit 21B independently of each other, it is possible to individually control output of each of the suction blowers 18A, 18B, and 18C and to individually control negative pressure in the upstream suction unit 16, the downstream suction unit 21A, and the auxiliary suction unit 21B. In addition, for example, even in a case where the upstream suction unit 16 is open without being covered with the corrugated fiberboard 100a when transporting the corrugated fiberboard 100a, negative pressure in the downstream suction unit 21A can be maintained constant, and thus it is possible to stably transport the corrugated fiberboard 100a.

Since suction power of each of the suction blower 18A to 18C is configured to be adjustable based on a weight per unit area of the transported corrugated fiberboard 100a, various types of corrugated fiberboards 100a having weights per unit area different from each other can be sufficiently pulled to the feed rollers 11b due to such suction power adjustment, and thus stable transporting is possible.

The plurality of suction boxes 16N1 to 16N8, 21AN1 to 21AN8, and 21BN1 to 21BN8 are provided along the sheet width direction W in the upstream suction unit 16, the downstream suction unit 21A, and the auxiliary suction unit 21B, and the supply of suction power to the suction boxes 16N1 to 16N8, 21AN1 to 21AN8, and 21BN1 to 21BN8, which are arranged in the sheet width direction W, can be controlled by the shutter members 30 according to a width dimension of the corrugated fiberboard 100a. Therefore, out of the suction boxes 16N1 to 16N8, 21AN1 to 21AN8, and 21BN1 to 21BN8, which are provided along the sheet width direction W, a suction box to be operated can be set according to a sheet width dimension of the corrugated fiberboard 100a without excess or insufficiency.

### 2. Second Embodiment

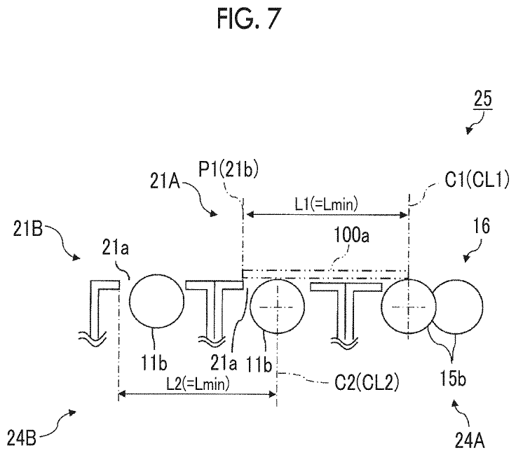

Next, a corrugated fiberboard feeding apparatus 25 according to a second embodiment will be described with reference to FIG. 7.

A box making machine of the second embodiment is configured in the same manner as the first embodiment illustrated in FIGS. 1 to 6, except for a sheet feeding section.

Reference signs in FIG. 7 that are the same as the reference signs of FIGS. 1 to 6, which are referred in the description of the first embodiment, indicate the same configuration elements, and detailed description thereof will be omitted.

[2-1. Corrugated Fiberboard Feeding Apparatus]

A difference between the corrugated fiberboard feeding apparatus 25 according to the second embodiment and the corrugated fiberboard feeding apparatus 24 according to the first embodiment is that the feed roller assemblies 11 accommodated in the downstream suction unit 21A and the auxiliary suction unit 21B are in one row.

Even in this case, as in the corrugated fiberboard feeding apparatus 24 according to the first embodiment, the corrugated fiberboard feeding apparatus 25 is configured such that the distances L1 and L2 are equal to or shorter than the minimum length Lmin (L1≤Lmin, L2≤Lmin). In the embodiment, the distances L1 and L2 are set to the same dimension as the minimum length Lmin (L1=Lmin, L2=Lmin).

Since other configurations of the sheet feeding apparatus 25 are the same as the configurations of the sheet feeding apparatus 24 of the first embodiment, description thereof will be omitted.

[2-2. Operation and Effect]

Therefore, in the corrugated fiberboard feeding apparatus 25 according to the embodiment, the same effects as the corrugated fiberboard feeding apparatus 24 according to the first embodiment are obtained. In addition, in a case where sufficient transporting power is obtained even when the number of feed roller assemblies 11 in the downstream suction unit 21A and the auxiliary suction unit 21B is suppressed to one row of feed roller assemblies depending on characteristics such as a maximum weight or a basis weight of the transported corrugated fiberboard 100a, it is possible to reduce the number of components, thereby making the embodiment effective.

In addition, the downstream suction unit 21A and the auxiliary suction unit 21B are likely to be miniaturized by the amount of a decrease in the number of feed roller assemblies 11 compared to the first embodiment, although the miniaturization also depends on the dimension of each of the feed rollers 11b. Even when the minimum length Lmin is small, the distances L1 and L2 are likely to be set to the minimum length Lmin or shorter.

[3. Others]

Although the embodiments of the present invention are described hereinbefore, the present invention is not limited to each of the embodiments described above, and can be executed after making appropriate modification, omission, or combination without departing from the spirit of the present invention.

(1) It is also possible to press the transported corrugated fiberboard 100a by adopting, for example, a spring plate or an air blow instead of the pressing rolls 19.

(2) In addition, in each of the embodiments, suction power acting on the upstream suction unit 16, the downstream suction unit 21A, and the auxiliary suction unit 21B is adjusted by the control section 20 controlling the output of the suction blowers 18A, 18B, and 18C. On the contrary, a damper is placed in each of the ducts 17A, 17B, and 17C that connect the suction blowers 18A, 18B, and 18C to the upstream suction unit 16, the downstream suction unit 21A, and the auxiliary suction unit 21B. By adjusting opening degrees of the dampers in accordance with a command from the control section 20 or manual operation of an operator, suction power acting on the upstream suction unit 16, the downstream suction unit 21A, and the auxiliary suction unit 21B may be adjusted. In a case where the control section 20 controls the opening degrees of the dampers, the dampers and the control section 20 configure the adjusting means of the present invention, which adjusts suction power. In a case where an operator manually adjusts the dampers, the dampers configure the adjusting means of the present invention, which adjusts suction power.

(3) Although two units including the downstream suction unit 21A and the auxiliary suction unit 21B are provided in the downstream transporting unit 24B in each of the embodiments, only one suction unit may be provided, or three or more suction units may be provided in the downstream transporting unit 24B.

(4) Although the openings 21a that allow the feed rollers 11b to protrude are also used as suction ports through which suction power acts on the corrugated fiberboard 100a in each of the embodiments, suction ports may be provided separately from the openings 21a.

### REFERENCE SIGNS LIST

1: sheet feeding section (sheet processing unit)

2: printing section (sheet processing unit)

3: slotter creaser section (sheet processing unit)

4: die cutting section (sheet processing unit)

5: folder gluer section (sheet processing unit)

6: counter-ejector section (sheet processing unit)

11b: feed roller

12: front guide

13: backstop

14: paper supply table

15: ejection roller assembly

15a: rotary shaft

15b: ejection roller

16: upstream suction unit

16N1 to 16N8, 21AN1 to 21AN8, 21BN1 to 21BN8: suction

16a: grate

16b: opening

17A, 17B, 17C: duct

18A, 18B, 18C: suction blower

19: pressing roll

20: control section

21A: downstream suction unit

21B: auxiliary suction unit

21a: opening

21b: downstream end of opening 21a

22: transport conveyor belt

24, 25: corrugated fiberboard feeding apparatus

30: shutter mechanism

30a: air cylinder

30b: shutter member

100: corrugated box

100a: corrugated fiberboard

CL1, CL2: axis of ejection roller 15b

L1: distance between downstream end 21b of opening 21a and axis CL1 of ejection roller 15b

L2: distance between downstream end 21b of opening 21a and axis CL2 of feed roller 11b

Lmin: minimum length of corrugated fiberboard

1. A corrugated fiberboard feeding apparatus comprising:
an upstream transporting unit that has a plurality of ejection rollers which eject a corrugated fiberboard placed on upper surfaces thereof, and transports the corrugated fiberboard placed on the ejection rollers; and
a downstream transporting unit that is adjacent to a downstream side in a sheet transfer direction with respect to the upstream transporting unit and transports the corrugated fiberboard ejected from the upstream transporting unit to a sheet processing unit on the downstream side,
wherein the downstream transporting unit has
a downstream suction unit that has an opening facing a sheet transport passage, and
a feed roller that is accommodated in the downstream suction unit and has an outer circumferential surface of which a part protrudes to a sheet transport passage side, and
a distance in the sheet transfer direction between a downstream end of the opening in the sheet transfer direction and an axis of the ejection roller on the most downstream side in the sheet transfer direction, out of the plurality of ejection rollers, is set to a maximum distance of a mutual distance between a plurality of transport rollers of the sheet processing unit, which transport the corrugated fiberboard, or shorter.

2. The corrugated fiberboard feeding apparatus according to claim 1,
wherein the downstream transporting unit further has, above the feed roller, a pressing mechanism that regulates an upper surface of the ejected corrugated fiberboard.

3. The corrugated fiberboard feeding apparatus according to claim 2,
wherein the pressing mechanism is a pressing roll that comes into contact with the upper surface of the corrugated fiberboard which is being transported, is rotatably provided, and includes a hollow portion.

4. The corrugated fiberboard feeding apparatus according to claim 1,
wherein a plurality of the feed rollers are arranged in the sheet transfer direction.

5. The corrugated fiberboard feeding apparatus according to claim 4,
wherein the plurality of the feed rollers are further arranged along a sheet width direction orthogonal to the sheet transfer direction and are arranged in a zigzag.

6. The corrugated fiberboard feeding apparatus according to claim 1,
wherein a plurality of the feed rollers are provided,
the opening is provided at each position of the plurality of the feed rollers, and
each of the feed rollers has the outer circumferential surface of which a part protrudes from the opening.

7. The corrugated fiberboard feeding apparatus according to claim 1,
wherein the downstream transporting unit has
an auxiliary suction unit that is disposed on the downstream side of the downstream suction unit and has an opening facing the sheet transport passage, and
a feed roller that is accommodated in the auxiliary suction unit and has an outer circumferential surface of which a part protrudes to the sheet transport passage.

8. The corrugated fiberboard feeding apparatus according to claim 7, further comprising:
an upstream suction unit on an upstream side of the downstream suction unit,
wherein the upstream suction unit, the downstream suction unit, and the auxiliary suction unit are each independently connected with a suction blower.

9. The corrugated fiberboard feeding apparatus according to claim 7, further comprising:
an upstream suction unit on an upstream side of the downstream suction unit,
wherein adjusting means for adjusting suction power is included in each of the upstream suction unit, the downstream suction unit, and the auxiliary suction unit.

10. The corrugated fiberboard feeding apparatus according to claim 8,
wherein suction power of each of the suction blowers is configured to be adjustable based on a weight per unit area of the transported corrugated fiberboard.

11. The corrugated fiberboard feeding apparatus according to claim 8, further comprising:
an upstream suction unit on an upstream side of the downstream suction unit,
wherein a plurality of suction boxes are provided, along a sheet width direction orthogonal to the sheet transfer direction, in at least one suction unit of the upstream suction unit, the downstream suction unit, and the auxiliary suction unit, and
in each passage that connects the plurality of suction boxes to the suction blowers, a shutter member that opens and closes the passage is included.

12. The corrugated fiberboard feeding apparatus according to claim 8,
wherein the upstream transporting unit includes
a grate that separates the corrugated fiberboard on the lowermost layer away from the plurality of ejection rollers at a raised position higher than a height of each of upper edges of the plurality of ejection rollers, and brings the corrugated fiberboard on the lowermost layer into contact with the ejection rollers at a lowered position lower than the height of each of the upper edges, and
a drive device that drives the grate to raise and lower the grate between the raised position and the lowered position,
adjusting means for adjusting suction power is included in each of the upstream suction unit and the downstream suction unit, and
the adjusting means sets at least the suction power of the downstream suction unit to the suction power of the upstream suction unit or larger.

13. A box making machine comprising:
a sheet feeding section that feeds a corrugated fiberboard one by one;
a printing section that prints the corrugated fiberboard fed from the sheet feeding section;
a slotter creaser section that performs groove cutting and creasing line processing onto the corrugated fiberboard printed by the printing section;
a die cutting section that performs punching processing onto the corrugated fiberboard on which the groove cutting and the creasing line processing are performed;
a folder gluer section that applies glue to an end portion of the corrugated fiberboard processed by the die cutting section and performs folding processing to form a sheet-like corrugated box; and
a counter-ejector section that stacks the corrugated box processed by the folder gluer section while counting the number of the corrugated box,
wherein the corrugated fiberboard feeding apparatus according to claim 1 is provided in the sheet feeding section.
